(19) United States
(12) Patent Application Publication
(10) Pub. No.: US 2007/0162532 A1
(43) Pub. Date: Jul. 12, 2007

(54) Method for generating at least one random number

(76) Inventors: Holger Ceskutti, Moeckmuehl (DE); Klaus Schneider, Ludwigsburg (DE); Ioannis Liakos, Stuttgart (DE)

Correspondence Address: KENYON & KENYON LLP, ONE BROADWAY, NEW YORK, NY, 10004, US

(21) Appl. No.: 11/637,459

(22) Filed: Dec. 11, 2006

(30) Foreign Application Priority Data
Dec. 9, 2005 (DE) 102005059320.8

(51) Int. Cl. G06F 7/58

(52) U.S. Cl. 708/250

(57) ABSTRACT

In a method for generating at least one random number for a system, at least one pseudo-random input value is used which is generated while taking into consideration of a boundary condition.

### BACKGROUND INFORMATION

Special algorithms are used, as a rule, to generate random numbers or pseudo-random numbers. Thus, algorithms are known, for example, for calculating variance coefficients or so-called hash values from data sets such as, for instance, from storage areas.

In German Patent Application No. DE 102 16 396, a method is introduced for authenticating between at least two cryptographic entities of a communications system. In this case, it is provided that a first entity generates at least one first random number and reads out a serial number from a second entity. Furthermore, the first entity generates a challenge or query, by encoding a concatenation, a linking of sets, of at least one first random number and the serial number having a public key of an asymmetrical key pair.

### SUMMARY OF THE INVENTION

In the method according to the present invention for generating at least one random number for a system, at least one pseudo-random input value is used which is generated under consideration of a boundary condition of the system.

In one preferred embodiment, the at least one pseudo-random input value is derived from at least one parameter, which is a function of at least one operating state of the system, as a possible boundary condition.

The boundary condition may be determined by the at least one operating state and/or additional values, that preferably change, which are able to be recorded by the system, such as, for instance, a temperature measurable by the system or other physical quantities which come about from changing environmental conditions or interactions of the system with other devices.

The at least one random number changes as a function of time, particularly if the at least one pseudo-random input value is derived from at least one parameter that changes with time. The change with time of the at least one parameter thus comes about based on a preferably dynamically changing operating state of the system.

In a further embodiment it is provided that the at least one pseudo-random input value, usually a plurality of such input values and possibly additional values, such as at least one source value, or so-called seed value, are concatenated to form a data block. At least one variance coefficient or hash value is able to be formed via this data block, using a suitable algorithm. The at least one random number is made available, for example, after a plurality of iterations which take into account the values named above.

Alternatively, it is conceivable that one might generate the at least one random number, by suitable mathematical methods, from the at least one input value.

The present invention also relates to a system that is designed to generate at least one random number using at least one pseudo-random number, the at least one pseudo-random input value being able to be generated under consideration of a boundary condition of the system.

The system is designed to make available at least one parameter that is a function of an operating state of the device, from this at least one parameter the pseudo-random input value being able to be derived.

The system is able to have at least one module. This at least one module is designed for recording the boundary condition, especially of the parameter characterizing the boundary condition, and/or for generating the at least one random number from the at least one pseudo-random input value.

The at least one random number that is able to be generated by the method according to the present invention and/or using the device according to the present invention can be used for the system, but also for other equipment.

The present invention further relates to a computer program having program code means for implementing all of the steps of a method according to the present invention if the computer program is executed on a computer or a corresponding central processing unit, particularly in a system according to the present invention.

The computer program product according to the present invention having program code means, that are stored on a computer-readable storage medium, is suitable for executing all the steps of the method according to the present invention if the computer program is executed on a computer or a corresponding central processing unit, in particular in a system according to the present invention.

The present invention makes possible generating random numbers in preferably embedded systems, while using hash algorithms, by which hash values or variance coefficients are made available, and iterations. In this instance, the pseudo-random, or in a certain manner, as it were, random input value is made available from a protected input source, in the present case, the system. This procedure makes it very difficult for a potential attacker to influence the at least one random number generated according to the present invention in his sense, such as to hold it constant.

Consequently, using the present invention, a generation, that is secured and resource-optimized from cryptographic points of view, of the at least one random number is made possible, taking into consideration the boundary conditions of the system, such as a control unit or an engine controller for a vehicle, and thus a system embedded in a device. The present invention is, for example, also suitable in control unit manufacturing of engine control units for vehicles.

### BRIEF DESCRIPTION OF THE DRAWINGS

FIG. 1 shows a diagram of a preferred specific embodiment for generating at least one random number.

FIG. 2, in a schematic representation, shows a preferred specific embodiment of a system for generating at least one random number.

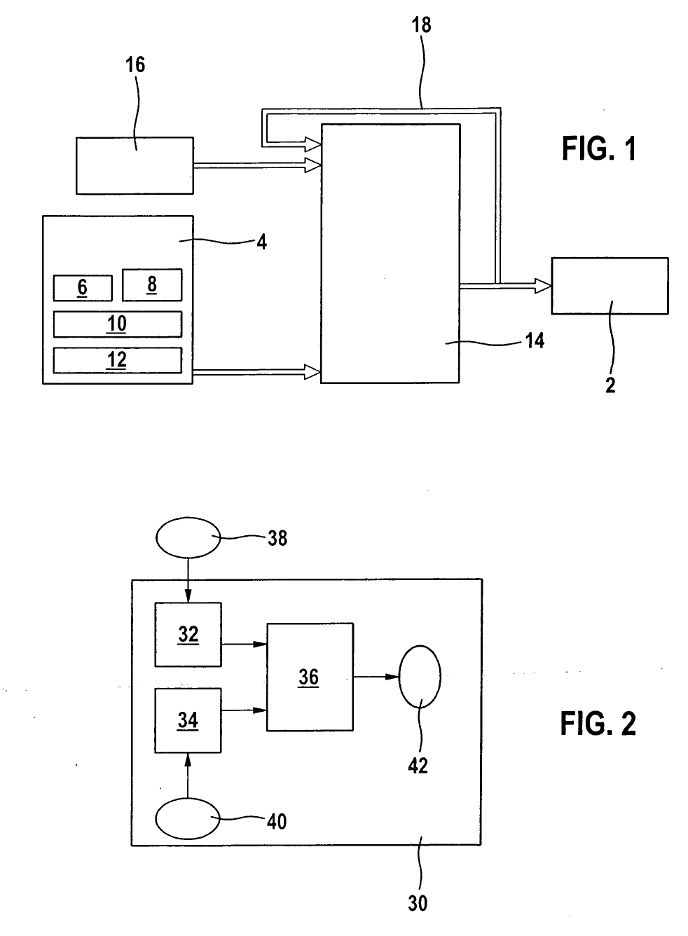

### DETAILED DESCRIPTION

Various pseudo-random number input values 4 are used for generating or producing random number 2 for a system. In this context, at least one pseudo-random input value 4 is generated while taking into consideration a boundary condition of the system. This at least one pseudo-random input value 4 is derived, in the present specific embodiment of the present invention, from at least one parameter 6, 8, 10, 12, which is a function of an operating state of the system.

A plurality of such pseudo-random input values 4 is concatenated to form a data block 14, via which a hash value or variance coefficient value is formed, using the at least one hash value algorithm or variance coefficient algorithm.

The variance coefficient is used to prevent drawing conclusions as to input values 4 from random number 2, by as great as possible a scrambling. Quite minimal changes in an input value 4 result in a change in the variance coefficient that is not inversely calculable, and is most probably massive.

At least in one part of input values 4, pseudo-random values for operating state-dependent parameters 6, 8, 10, 12 are involved, such as results 6 from analog-digital converters (ADC), values 8 of a timer or counter, values 10 for rapidly changing storage areas in a working memory (RAM) or other quantities 12 changing with time, which are characterized by boundary conditions of the system.

In principle, all pseudo-random input value 4 are able to be influenced from outside. A block of secret data 16, so-called seed values or source values, that is further provided protected as well as possible against reading out and manipulating, additionally makes more difficult the influencing of random number 2 from the outside. Such influencing might be conceivable, for example, by applying a fixed voltage to the terminals of a microcontroller (μC pins).

Depending on requirement and resource situation, a process, which in this case includes making available the at least one pseudo-random input value 4 as well as source value 16 and formation of a variance coefficient over data block 14, is able to be carried out as often as desired by n iterations 18, in order thus to reduce the ability to influence random number 2 as well as inverse calculability of the at least one pseudo-random input value 4.

System 30 shown schematically in FIG. 2, in preferred specific embodiment, has a first module 32, a second module 34 and a third module 36. First module 32 and second module 34 are developed, in this context, for recording boundary conditions 38, 40 of system 30. First boundary condition 38, which is able to be recorded by first module 32, in this instance, is an environmental condition to which system 30 is exposed during operation. Second boundary condition 40, which is able to be recorded by second module 34, is an operating state of system 30. From parameters that are a function of these boundary conditions 38, 40, pseudo-random input values are derived, from which third module 36 of system 30 generates at least one random number 42, supported by the computer.

What is claimed is:

1. A method for generating at least one random number for a system, comprising:
generating at least one pseudo-random input value as a function of a boundary condition of the system; and
generating the at least one random number as a function of the at least one pseudo-random input value.

2. The method according to claim 1, wherein the at least one pseudo-random input value is derived from at least one parameter which is a function of an operating state of the system.

3. The method according to claim 1, further comprising concatenating the at least one pseudo-random input value to form a data block.

4. The method according to claim 3, wherein the at least one pseudo-random input value is concatenated with at least one source value to form the data block.

5. The method according to claim 3, wherein at least one variance coefficient is formed via the data block, and from this the at least one random number is made available.

6. A system for generating at least one random number for a system, comprising:
an arrangement for generating at least one pseudo-random input value as a function of a boundary condition of the system; and
an arrangement for generating the at least one random number as a function of the at least one pseudo-random input value.

7. The system according to claim 6, wherein at least one parameter that is a function of an operating state of the system is provided, the pseudo-random input value being derived from the at least one parameter.

8. The system according to claim 6, wherein the system is a control unit.

9. A computer-readable medium containing a computer program which when executed by a processor performs the following method for generating at least one random number for a system:
generating at least one pseudo-random input value as a function of a boundary condition of the system; and
generating the at least one random number as a function of the at least one pseudo-random input value.
